(19) United States
(12) Patent Application Publication
(10) Pub. No.: US 2020/0099862 A1
(43) Pub. Date: Mar. 26, 2020

(54) MULTIPLE FRAME IMAGE STABILIZATION

(71) Applicant: QUALCOMM Incorporated, San Diego, CA (US)

(72) Inventors: Yihe Yao, San Diego, CA (US); Lei Ma, San Diego, CA (US); Fanxing Kong, San Diego, CA (US); Nan Jiang, San Diego, CA (US)

(21) Appl. No.: 16/138,644

(22) Filed: Sep. 21, 2018

(51) Int. Cl. H04N 5/232; G06T 5/00; G06T 7/20; G06T 7/70; G06T 5/50

(52) U.S. Cl. CPC H04N 5/23267; G06T 5/002; G06T 5/50; G06T 7/70; G06T 7/20

(57) ABSTRACT

Aspects of the present disclosure relate to systems and methods for performing multiple frame electronic image stabilization (EIS). An example device may include a memory and a processor configured to receive a current frame for performing multiple frame EIS, determine a location of a cropping in the current frame for an EIS image, and crop current image information from the current frame using the cropping. The cropped current image information is included in the EIS image. The processor further may be configured to determine a portion of the cropping for the EIS image not in the current frame, retrieve from the memory prior image information for the portion of the cropping from one or more prior frames in response to determining the portion of the cropping not in the current frame, and generate, for the current frame, the EIS image including the current image information and the prior image information.

### TECHNICAL FIELD

This disclosure relates generally to systems and methods for image capture devices, and specifically to image stabilization using multiple image frames.

### BACKGROUND OF RELATED ART

Many devices include or are coupled to one or more cameras for generating images or video of a scene. For video, a stream of image frames are captured by the camera. Each captured frame is processed by the camera or device, and a video is output. For handheld devices or cameras (such as digital cameras, smartphones, tablets, etc.), the camera may be moving when capturing the image frames. For example, a person recording a video with his or her smartphone may have a shaking hand, may be walking, or otherwise may be moving, which may cause the camera to move during image frame capture. Many devices perform electronic image stabilization (EIS) to compensate for the camera movement. EIS is a post capture operation that may be performed by the camera or device to smooth jerkiness or other movements in the captured video.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to systems and methods for performing multiple frame electronic image stabilization (EIS). An example device may include a memory and a processor configured to receive a current frame for performing multiple frame EIS, determine a location of a cropping in the current frame for an EIS image, and crop current image information from the current frame using the cropping. The cropped current image information is included in the EIS image. The processor further may be configured to determine a portion of the cropping for the EIS image not in the current frame, retrieve from the memory prior image information for the portion of the cropping from one or more prior frames in response to determining the portion of the cropping not in the current frame, and generate, for the current frame, the EIS image including the current image information and the prior image information.

In another example, a method is disclosed. The example method includes receiving, by a processor, a current frame for multiple frame EIS, determining a location of a cropping in the current frame for an EIS image, and cropping current image information from the current frame using the cropping. The cropped current image information is included in the EIS image. The method also includes determining a portion of the cropping for the EIS image not in the current frame, retrieving, from a memory, prior image information for the portion of the cropping from one or more prior frames in response to determining the portion of the cropping not in the current frame, and generating, for the current frame, the EIS image including the current image information and the prior image information.

In a further example, a non-transitory computer-readable medium is disclosed. The non-transitory computer-readable medium may store instructions that, when executed by a processor, cause a device to receive a current frame for multiple frame EIS, determine a location of a cropping in the current frame for an EIS image, and crop current image information from the current frame using the cropping. The cropped current image information is included in the EIS image. Execution of the instructions further cause the device to determine a portion of the cropping for the EIS image not in the current frame, retrieve, from a memory, prior image information for the portion of the cropping from one or more prior frames in response to determining the portion of the cropping not in the current frame, and generate, for the current frame, the EIS image including the current image information and the prior image information.

In another example, a device is disclosed. The device includes means for receiving a current frame for multiple frame EIS, means for determining a location of a cropping in the current frame for an EIS image, and means for cropping current image information from the current frame using the cropping. The cropped current image information is included in the EIS image. The device further includes means for determining a portion of the cropping for the EIS image not in the current frame, means for retrieving prior image information for the portion of the cropping from one or more prior frames in response to determining the portion of the cropping not in the current frame, and means for generating, for the current frame, the EIS image including the current image information and the prior image information.

### BRIEF DESCRIPTION OF THE DRAWINGS

Aspects of the present disclosure are illustrated by way of example, and not by way of limitation, in the figures of the accompanying drawings and in which like reference numerals refer to similar elements.

FIG. 1 is a depiction of an example sequence of image frames for which EIS is performed.

FIG. 2 is a depiction of another example sequence of image frames for which EIS is performed.

FIG. 3 is a depiction of a further example sequence of image frames for which EIS is performed.

FIG. 4 is a depiction of example frames for which EIS is not performed.

FIG. 5 is a block diagram of an example device for performing multiple frame EIS.

FIG. 6 is a depiction of example frames for performing multiple frame EIS.

FIG. 7 is an illustrative flow chart depicting an example operation for performing multiple frame EIS.

FIG. 8 is an illustrative flow chart depicting a pixel-by-pixel example operation for performing multiple frame EIS.

### DETAILED DESCRIPTION

Aspects of the present disclosure may be used for performing multiple frame electronic image stabilization (EIS). For some devices including cameras (such as smartphones, tablets, digital cameras, or other handheld devices), the camera may be moving during recording. For example, a user's hand may shake, the user may be walking, the device may be vibrating, or the user may move in other ways to cause the camera to move. The camera movement may cause the video to appear shaky, jerky, or include other global motion (for which the entire scene moves in the frames as a result of the camera movement) that may not be desired by a viewer. A device may perform EIS to smooth the global motion in the video.

For EIS, frames of a video are captured by a camera, and the frames are processed after capture to reduce motion in the video caused by camera movement. The device may crop each captured frame to a percentage of the captured frame's size (such as 90 percent), and the cropped frame may be used for the video. Since the cropped frame is smaller than the respective captured frames, the device may move the location of the cropping within each captured frame to reduce the global motion.

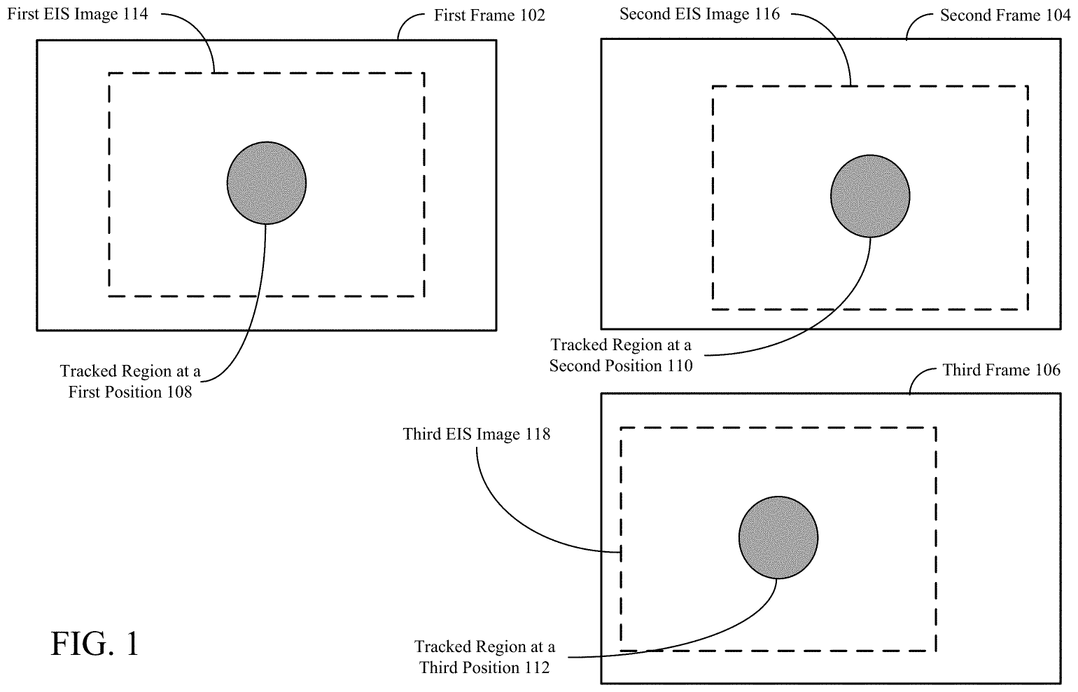

FIG. 1 is a depiction of an example sequence of image frames 102-106 for which EIS is performed. The video may be tracking a region of the scene. In some examples, the region may be the center of the camera's field of capture when video recording begins. In some other examples, the region may be a region of interest (ROI) that may be defined by the user (such as the user selecting a portion of a preview image to be the ROI) or defined by the device (such as the device using facial identification to identify an ROI including a face in a preview image). For the video including the first frame 102, the second frame 104, and the third frame 106, the scene moves based on global motion. For example, the tracked region may be at a first position 108 in the first frame 102, may be at a second position 110 in the second frame 104, and may be at a third position 112 in the third frame 106.

With EIS, the first EIS image 114 may be a cropped version of the first frame 102. A device may attempt to center the first EIS image 114 at the tracked region at the first position 108. The camera moves between capturing the first frame 102 and capturing the second frame 104, and the tracked region appears at a second position 110 different from the first position 108 in the second frame 104. The device may attempt to center the second EIS image 116 at the tracked region at the second position 110. In some other examples, the device may move the second EIS image 116 toward centering the tracked region, but the center of the second EIS image 116 may be somewhere between the first position 108 and the second position 110. Similarly, for a third frame 106 with the tracked region at a third position 112, the device may attempt to center or move the center of the third EIS image 118 toward the third position 112. In this manner, global motion in the video is reduced.

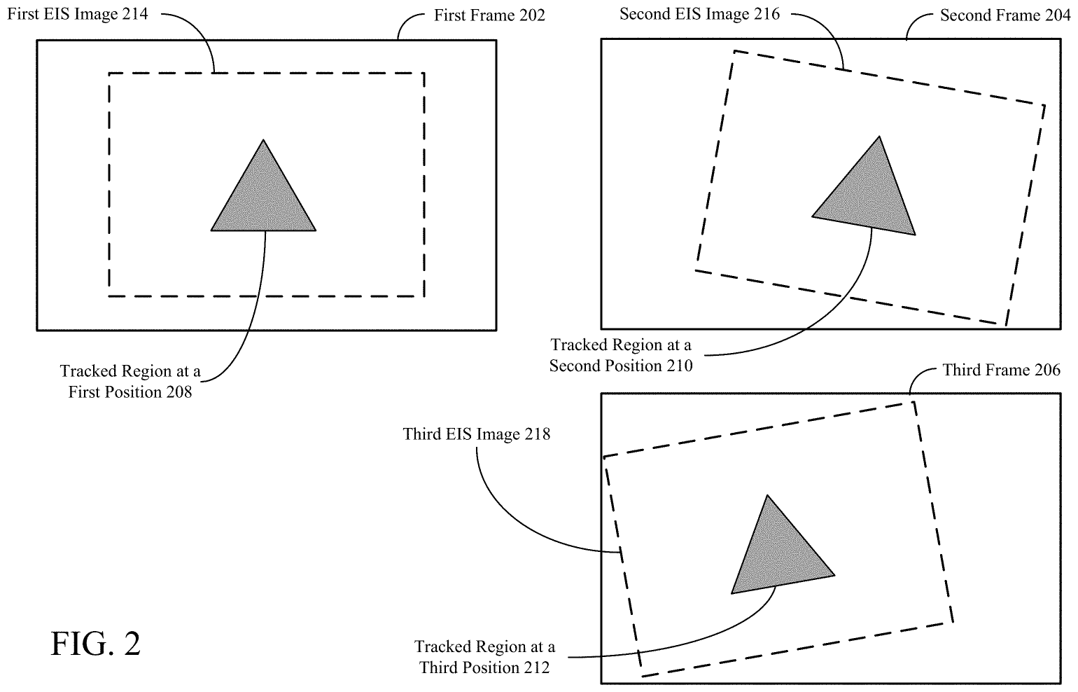

While FIG. 1 illustrates global motion based on a positional movement of the camera, the camera also may have rotational movement (such as roll). As a result, the scene in the captured frames may rotate based on the camera's rotation. FIG. 2 is a depiction of another example sequence of image frames 202-206 for which EIS is performed. Similar to FIG. 1, the tracked region may move positions from a first position 208 for the first frame 202, to a second position 210 for the second frame 204, to a third position 212 for the third frame 206. In addition, the tracked region may rotate between frames 202-206. The croppings for the EIS images 214-218 may be moved and rotated within the respective captured frame 202-206 to compensate for global motion caused by positional and rotational movements of the camera.

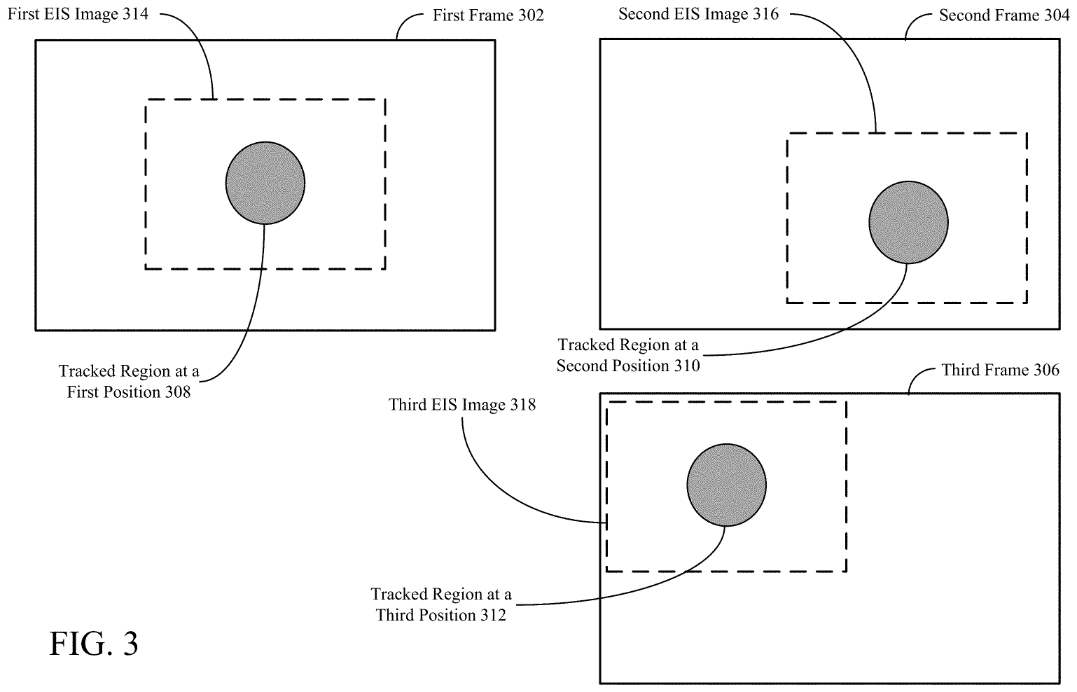

For conventional EIS, the size of the croppings for the EIS images may be fixed or based on the amount of global motion. If the cropping size is based on the amount of global motion, the cropping may be smaller for more global motion. FIG. 3 is a depiction of a further example sequence of image frames 302-306 for which EIS is performed. There is more global motion for the frames 302-306 in FIG. 3 than for the frames 102-106 in FIG. 1. As a result, the device may shrink the size of the respective croppings for the EIS images 314-318 in order to be able to move the croppings for the EIS images 314-318 to keep tracking the region from the first position 308, to the second position 310, and to the third position 312. While the device may reduce global motion with EIS, the resolution of a resulting video may be significantly reduced as a result of the smaller size croppings. The device may include a minimum cropping size to prevent the EIS images from being too low in resolution.

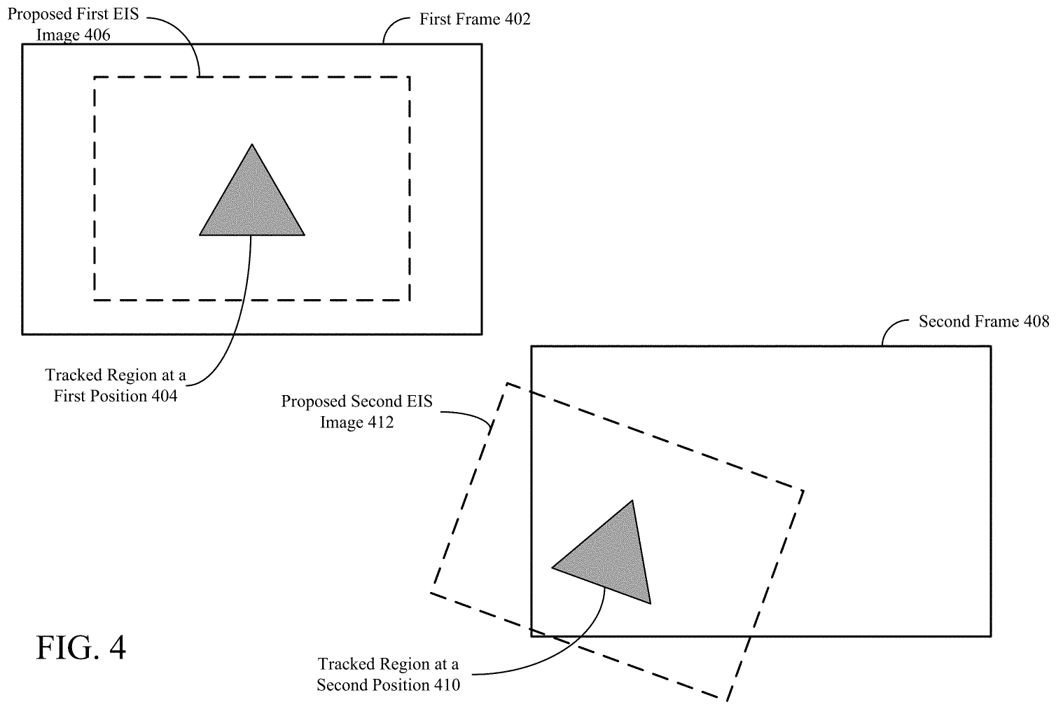

If the cropping size is fixed or a device includes a minimum cropping size, the device may compensate for a limited amount of global motion for the camera. If the global motion is too great for the fixed or minimum cropping size, the device may not be able to perform EIS. FIG. 4 is a depiction of example frames 402 and 408 for which EIS is not performed. Global motion may cause the tracked region to appear at a first position 404 in the first frame 402 and may cause the tracked region to appear at a second position 410 in the second frame 408. If the proposed first EIS image 406 and the proposed second EIS image 412 are of fixed size or a minimum size, the proposed second EIS image 412 to track the region at the second position 410 may include portions outside of the second frame 408. Since a portion of the proposed EIS image 412 would be outside of the second frame 408, no information would exist for those portions of the EIS image 412. As a result, the device may not perform EIS.

In some example implementations, a device may use multiple captured frames in performing EIS. For example, referring back to FIG. 4, a device may determine that one or more portions of the proposed second EIS image 412 are outside the second frame 408. The device thus may attempt to fill in the portions with information from one or more frames captured before the second frame 408 (such as the first frame 402 and/or a frame captured prior to the first frame 402). The device may store (such as in a buffer) one or more prior frames for use in multiple frame EIS. The number of prior frames to store or use may be based on the amount of global motion, constraints on device processing resources, application latency requirements, or other suitable factors for performing multiple frame EIS.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device for processing captured image frames (such as a security system with one or more cameras, smartphones, tablets, laptop computers, digital video and/or still cameras, web cameras, and so on). While described below with respect to a device having or coupled to one camera, aspects of the present disclosure are applicable to devices having any number of cameras (including no cameras, where a separate device is used for capturing images or video which are provided to the device), and are therefore not limited to devices having one camera. Aspects of the present disclosure may be implemented in devices having or coupled to cameras of different capabilities.

The term “device” is not limited to one or a specific number of physical objects (such as one smartphone, one camera controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects.

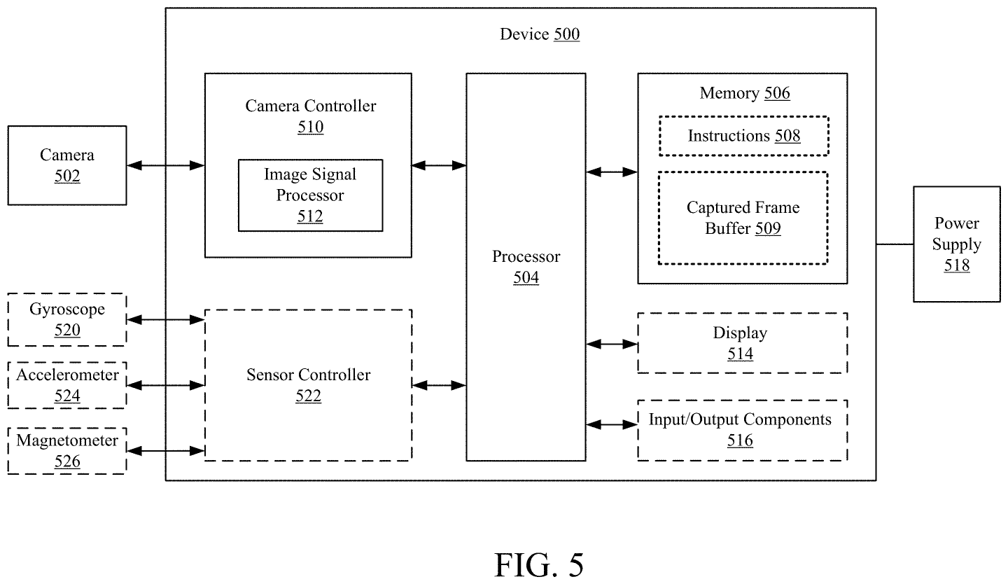

FIG. 5 is a block diagram of an example device 500 for performing multiple frame EIS. The example device 500 may include or be coupled to a camera 502, a processor 504, a memory 506 storing instructions 508, and a camera controller 510. The device 500 may optionally include (or be coupled to) a display 514, a number of input/output (I/O) components 516, and a sensor controller 522 coupled to a gyroscope 520. The device 500 may include additional features or components not shown. For example, a wireless interface, which may include a number of transceivers and a baseband processor, may be included for a wireless communication device. The device 500 may include or be coupled to additional cameras other than the camera 502. The disclosure should not be limited to any specific examples or illustrations, including the example device 500.

The camera 502 may be capable of capturing video (such as a stream of captured image frames). The camera 502 may include a single camera sensor and camera lens, or be a dual camera module or any other suitable module with multiple camera sensors and lenses. The memory 506 may be a non-transient or non-transitory computer readable medium storing computer-executable instructions 508 to perform all or a portion of one or more operations described in this disclosure. The memory 506 may also store a captured frame buffer 509 which may include one or more prior image frames captured by the camera 502. The captured frame buffer 509 may be used when performing multiple frame EIS. In some other examples, the captured frame buffer may be stored in a memory coupled to the camera controller 510 (such as to the image signal processor 512). The device 500 also may include a power supply 518, which may be coupled to or integrated into the device 500.

The processor 504 may be one or more suitable processors capable of executing scripts or instructions of one or more software programs (such as instructions 508) stored within the memory 506. In some aspects, the processor 504 may be one or more general purpose processors that execute instructions 508 to cause the device 500 to perform any number of functions or operations. In additional or alternative aspects, the processor 504 may include integrated circuits or other hardware to perform functions or operations without the use of software. While shown to be coupled to each other via the processor 504 in the example of FIG. 5, the processor 504, the memory 506, the camera controller 510, the optional display 514, the optional I/O components 516, and the optional sensor controller 522 may be coupled to one another in various arrangements. For example, the processor 504, the memory 506, the camera controller 510, the optional display 514, the optional I/O components 516, and/or the optional sensor controller 522 may be coupled to each other via one or more local buses (not shown for simplicity).

The display 514 may be any suitable display or screen allowing for user interaction and/or to present items (such as captured images, video, or a preview image) for viewing by a user. In some aspects, the display 514 may be a touch-sensitive display. The I/O components 516 may be or include any suitable mechanism, interface, or device to receive input (such as commands) from the user and to provide output to the user. For example, the I/O components 516 may include (but are not limited to) a graphical user interface, keyboard, mouse, microphone and speakers, and so on. The display 514 and/or the I/O components 516 may provide a preview image to a user and/or receive a user input for adjusting one or more settings of the camera 502.

The camera controller 510 may include an image signal processor 512, which may be one or more image signal processors to process captured image frames or video provided by the camera 502. The image signal processor 512 may perform multiple frame EIS in processing the captured frames from the camera 502. In some example implementations, the camera controller 510 (such as the image signal processor 512) may also control operation of the camera 502. In some aspects, the image signal processor 512 may execute instructions from a memory (such as instructions 508 from the memory 506 or instructions stored in a separate memory coupled to the image signal processor 512) to process image frames or video captured by the camera 502. In other aspects, the image signal processor 512 may include specific hardware to process image frames or video captured by the camera 502. The image signal processor 512 may alternatively or additionally include a combination of specific hardware and the ability to execute software instructions.

The sensor controller 522 may include or be coupled to one or more sensors for detecting motion of camera 502. In one example, the sensor controller 522 may include or be coupled to a gyroscope 520, an accelerometer 524, and/or a magnetometer 526. In some aspects, the gyroscope 520 may be used to determine movement of the camera 502. In one example, the gyroscope 520 may be a six-point gyroscope to measure the horizontal and/or vertical displacement of the camera 502. Additionally or alternatively, an accelerometer 524 may be used to determine movement of the camera 502 and/or a magnetometer 526 may be used to determine changes in the angle of the camera 502 relative to the Earth's magnetic plane. In some other implementations, successive camera image captures may be used to determine a global motion of the scene in the captures, thus determining movement of camera 502. For example, a first image capture and a second image capture from the camera 502 may be compared to determine if the camera 502 moves between capturing the first image frame and the second image frame.

The sensor controller 522 may include a digital signal processor (not shown), and the digital signal processor may be used to perform at least a portion of the steps involved for multiple frame EIS. For example, the sensor controller 522 may measure a camera movement, and the measured camera movement may be used in determining the number of frames to be buffered in the captured frame buffer 509. Additionally or alternatively, the measured camera movement may be used in determining how many frames to use for multiple frame EIS. In some other example implementations, the image signal processor 512 or the processor 504 may determine camera movement.

The following examples are described in relation to the device 500. However, any suitable device may be used, and the examples are provided for describing aspects of the present disclosure. The present disclosure should not be limited to device 500 or any specific device configuration.

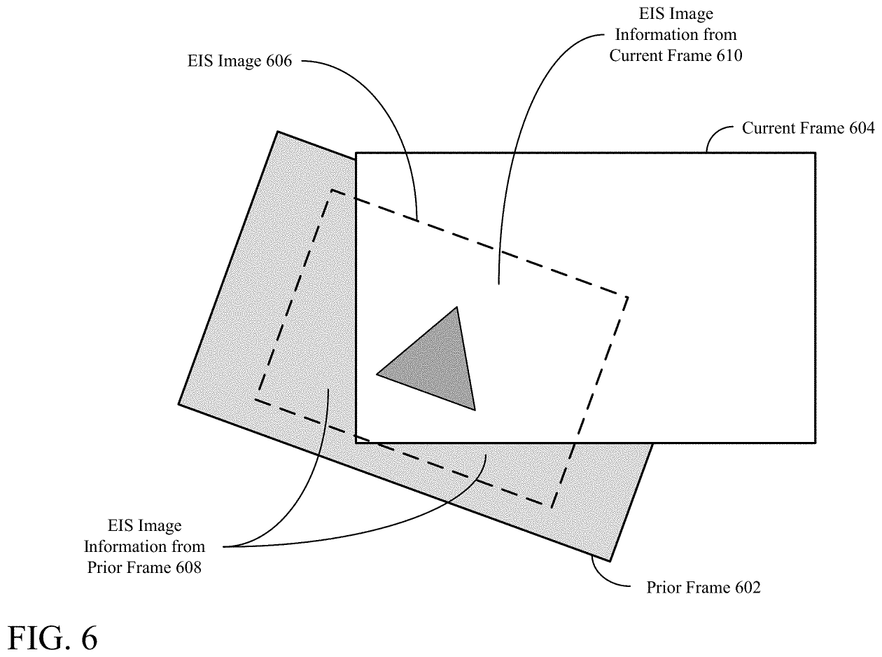

For multiple frame EIS, a prior captured frame may be used to fill in information of an EIS image missing from a current captured frame. FIG. 6 is a depiction of example frames 602 and 604 for performing multiple frame EIS. Portions of the EIS image 606 may be outside of the current frame 604, but the portions may be in a prior frame 602. The prior frame 602 may be the frame captured immediately before the current frame 604 or may be another frame captured before the current frame 604. In constructing the EIS image 606, the EIS image 606 may include image information 610 from the current frame 604 and may include image information 608 from the prior frame 602. While two frames 602 and 604 are shown in the example (with only one prior frame 602), any number of frames may be used in constructing the EIS image. For example, two or more prior frames may be used in constructing the EIS image for a current frame.

In some example implementations, the device 500 may stitch together the current frame and one or more prior frames to generate an overall image for the multiple frames. For example, the device 500 may use the immediately preceding frame to stitch additions to the current frame, then use the next preceding frame to stitch further additions, and so on. The device 500 may use any number of prior frames in making the overall image for the current frame. The device 500 then may determine the EIS image in the overall image for the current frame.

One problem with generating an overall frame before determining the EIS image is that the device 500 must construct the overall image before being able to determine the EIS image for the current frame. For example, referring back to FIG. 6, the device 500 may stitch together the prior frame 602 and the current frame 604 to make an overall image. The device 500 then may determine the EIS image 606 from the overall image. As a result, the device 500 may unnecessarily render portions of an overall image (such as the portions of the prior frame 602 not to be used in the EIS image 606). In another example, one or more prior frames used in constructing the overall image may not be used for the EIS image for the current frame. The device 500 therefore may unnecessarily use processing resources and time in constructing the overall image before determining the EIS image.

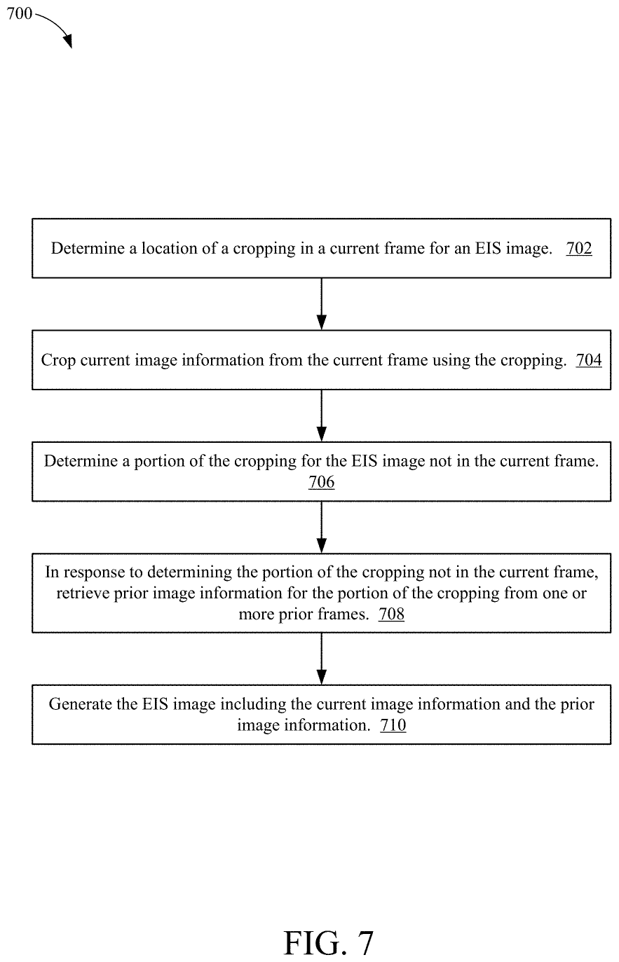

In some other example implementations, the device 500 may generate the portions of the EIS image not in the current frame (without constructing an overall image). FIG. 7 is an illustrative flow chart depicting an example operation 700 for performing multiple frame EIS. Beginning at 702, the device 500 may determine a location of a cropping in a current frame for an EIS image. The location may include a position of the cropping and a rotation of the cropping. Unlike conventional EIS, the device 500 does not need to place the entirety of the cropping within the current frame. Referring back to FIG. 6, the device 500 may determine the location of the cropping for the EIS image 606 to be partially outside of the current frame 604. Referring back to FIG. 7, after determining the location of the cropping in the current frame, the device 500 may crop current image information from the current frame using the cropping (704). The cropped image information may be used for the EIS image for the current frame (such as EIS image information 610 in FIG. 6).

The device 500 also may determine a portion of the cropping for the EIS image not in the current frame (706). The portion may include one or more pieces which may be connected or disconnected. For example, the portion for the cropping not in the current frame 604 in FIG. 6 is two disconnected pieces (filled by image information 608 from the prior frame 602). In response to determining the portion of the cropping not in the current frame, the device 500 may retrieve prior image information for the portion of the cropping from one or more prior frames (708). For example, the prior frame may be retrieved from the buffer 509, and the prior image information for the portion of the cropping may be determined from the retrieved prior frame. The device 500 then may generate the EIS image including the current image information and the prior image information (710).

The camera 502 may include a camera sensor with m×n pixels (such as 1600×1200, 2240×1680, 4064×2704, etc.) to capture frames of size m×n pixels. The camera 502 also may be configured to capture frames of different sizes. For example, the camera 502 may be configured to capture frames in formats of 720p (frame size of 1,280×720 pixels), 1080p (frame size of 1,920×1,080 pixels), WUXGA (frame size of 1,920×1,200 pixels), 2K (frame size of 2,048 columns), UHD/4K (frame size of 3,840×2,160 pixels), 8K (frame size of 7,680×4,320 pixels), or other suitable frame formats. If the size of the cropping for EIS is 90 percent of the size of the frames of size m×n pixels, the resulting EIS image may be 0.9*m×0.9*n pixels. For example, if captured frames from the camera 502 are of size 3,840×2,160 pixels (4K), an EIS image for a captured frame is of size 3,456×1,944 pixels.

In performing multiple frames EIS, the device 500 may determine which pixels of a resulting EIS image are to receive image information from the current capture (such as through cropping in 704 of FIG. 7), and the device 500 may determine which pixels of a resulting EIS image are to receive image information from a prior capture (such as through retrieving the prior image information in 708 of FIG. 7).

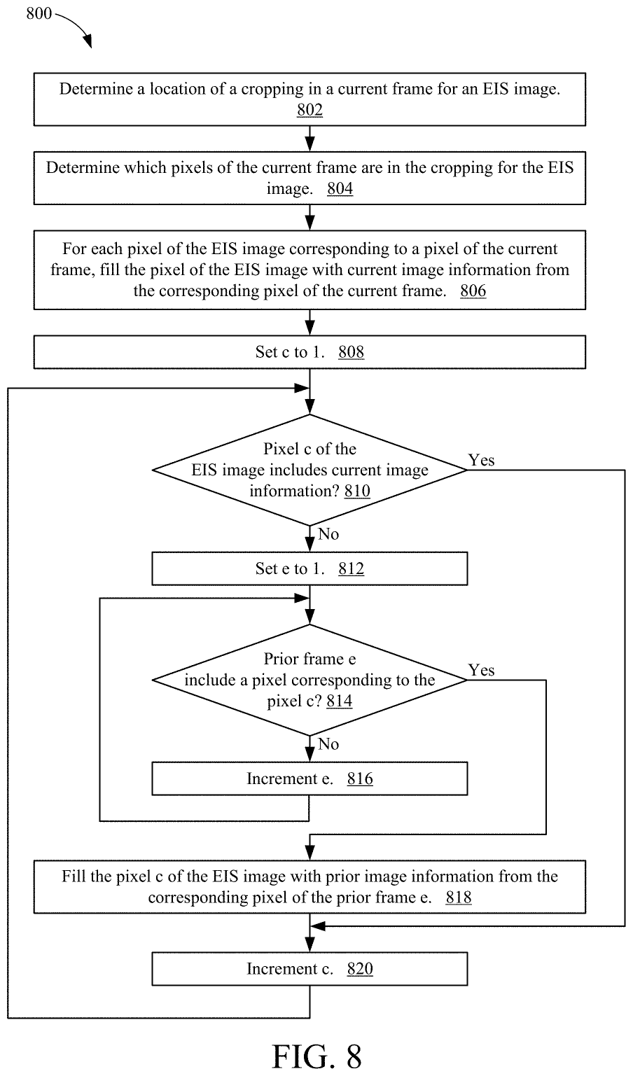

FIG. 8 is an illustrative flow chart depicting a pixel-by-pixel example operation 800 for performing multiple frame EIS. While the example operation 800 in FIG. 8 is described as being performed on a pixel-by-pixel basis, the device 500 may perform multiple frame EIS in other suitable ways (such as concurrently for regions of multiple pixels). Further, while the example operation 800 in FIG. 8 is described as analyzing pixels for the EIS image in a specific sequential order, the order of analyzing pixels of the EIS image may differ, and some analysis may be concurrent for different pixels. Example operation 800 is provided for illustrating some aspects of the present disclosure. However, the present disclosure should not be limited to the example operation 800.

Beginning at 802, after the device 500 receives the current frame from the camera 502, the device 500 may determine a location of a cropping in a current frame for an EIS image. The step may be similar to 702 in FIG. 7. The device 500 then may determine which pixels of the current frame are in the cropping for the EIS image (804). Each pixel of the current frame in the cropping may correspond to a pixel of the EIS image. The device 500 then may fill the pixels of the EIS image with current image information from the respective corresponding pixels of the current frame (806).

For the pixels of the EIS image not having current image information (no pixels of the current frame correspond to the pixels of the EIS image), the device 500 may fill each pixel with prior image information from a prior frame. In some example implementations, a prior frame 1 is the prior frame captured immediately before the current frame, a prior frame 2 is the prior frame captured immediately before the prior frame 1, and so on. Further, the EIS image may include C number of pixels (such as m*n=C). For example, if the captured frames are of size 3,840×2,160 pixels (4K), and the cropping size is 90 percent of the captured frame size, the number of pixels in the EIS image (C) is 3,456*1,944=6,718,464 pixels.

Referring to 808, c may be set to 1, and the device 500 may determine values for each pixel from 1 to C of the EIS image without current image information. In 810, the device 500 may determine if the pixel c of the EIS image includes current image information (from the current frame). If the pixel c is not yet filled with image information, the device 500 may set e to 1 (812), with the device determining which prior frame e to be used in filling the pixel c with image information. The device 500 thus may determine if prior frame e includes a pixel corresponding to the pixel c of the EIS image (814).

In some example implementations, the device 500 may retrieve the prior frame from a captured frame buffer 509. The device 500 then may align the prior frame e with the current frame. In one example, the device 500 may use object recognition in the current frame and the prior frame e. The device 500 then may align the current frame and the prior frame e so that the same objects in the current frame and the prior frame e are aligned. With the frames aligned, the device 500 may determine the pixels of the prior frame e outside the current frame that correspond to pixels of the EIS image for the current frame.

If no pixel in prior frame e corresponds to pixel c, the device 500 may increment e (816), and the process may revert to decision 814. In this manner, the device 500 may compare increasingly prior frames until a corresponding pixel is found for the pixel c.

The image information from the prior frames is older than the image information from the current frame. When using prior frames to fill portions of the EIS image, the information used from the prior frames may be stale. For example, if the camera 502 captures 30 frames per second (fps) when recording video, a frame is captured approximately every 33 milliseconds (ms). Therefore, information used from a prior frame is at least 33 ms older than the information from a current frame. Local motion in the scene (such as objects moving in the scene) may cause the portion of the scene taken from the prior frame to be different than when the current frame is captured. For example, a bird flying through the portion of the scene during capture may make the information from the prior frame not as relevant for the current frame. Earlier frame captures are even further removed in time from when the current frame is captured. Continuing the above example of the camera 502 capturing 30 fps, two frames before is captured 67 ms before capture of the current frame, three frames before is captured 100 ms before capture of the current frame, and so on.

Further, the amount of processing resources of device 500 required in determining the EIS image and the size of the captured frame buffer 509 increases as the number of prior frames to be used for multiple frame EIS increases. The device 500 may limit the number of prior frames to store and/or the number of prior frames to use for multiple frame EIS. In this manner, the device 500 may limit the processing resources and time needed for EIS. Further, the device 500 may prevent the image information for the EIS image from being too stale or old (such as if local motion in the scene causes changes to image information).

In some example implementations, the number of frames to be stored in buffer 509 is fixed. The buffer 509 may be a first in first out (FIFO) buffer of fixed length, and the oldest captured frame may be replaced with the current frame to store a fixed number of captured frames. For a fixed number of frames to be stored, the device 500 may use a fixed number of prior frames for EIS, or the device 500 may use an adjustable number of prior frames for EIS. In some other example implementations, the number of frames to be stored in the buffer 509 is adjustable. The number of frames to be stored, or the number of frames to be used, for multiple frame EIS may be based on the type of imaging application, the movement of the camera 502 (which may be determined by the sensor controller 522), a user input, the available processing resources of the device 500 (such as if the device is executing other applications limiting available resources for performing multiple frame EIS), or other suitable factor when using EIS in recording video.

Referring back to FIG. 8, if the device 500 reaches a maximum e (the oldest prior image to be used for multiple frame EIS), and the pixel c of the EIS image is not filled, the device 500 may determine that EIS should not be performed. As a result, the device 500 may disable or not use EIS for the current frame (and optionally for future frames).

In 814, if the prior frame e includes a pixel corresponding to the pixel c of the EIS image, the device 500 may fill the pixel c with the prior image information from the corresponding pixel of the prior frame e (818). c may be incremented (820), for the next pixel of the EIS image, and the process may revert to decision 810. Referring back to 810, if the pixel c of the EIS image includes current image information (from the current frame), c may be incremented (820), and the process reverts to decision 810.

The example operation 800 may continue until all pixels of the EIS image are filled (c=C). In some example implementations, the progression of c pixels to C may be left to right of the top row of the EIS image, left to right of the second row of the EIS image, and so on until progressing through all pixels of the bottom row of the EIS image. Any suitable ordering of the pixels may be used, though, and the present disclosure should not be limited to a specific ordering in filling the pixels for the EIS image. After filling each pixel of the EIS image, the device 500 may process the generated EIS image for the video recording. In the example operation 800 in FIG. 8, only the prior frames needed for filling a portion of the EIS image are used, and the device 500 is not required to take all stored prior frames and generate an overall image before generating an EIS image. In this manner, the device 500 may reduce processing resources and time in performing multiple frame EIS.

As stated above, the number of frames to be stored in the buffer 509 for multiple frame EIS may be based on any suitable device or operation characteristic (such as available processing resources for the device 500, type of imaging application, etc.). In one example, the number of frames to be stored is based on a latency requirement of the imaging application. For example, an imaging application to record video for later viewing may have a less stringent latency requirement than an imaging application providing video in near real-time. The device 500 may reduce the number of frames to be stored in the buffer 509 for near real-time imaging applications, and the device 500 may increase the number of frames to be stored in the buffer 509 for imaging applications that do not provide video in near real-time. The device 500 may adjust the size of the buffer or adjust the number of buffer entries that may be used for the multiple frame EIS for the imaging application.

In another example, the device 500 may adjust the number of frames to be stored based on the available processing resources of the device 500. For example, if the camera 502 captures higher resolution frames, the device 500 may need an increasing amount of resources to process the increased resolution frames. As a result, the device 500 may decrease the number of frames to store for multiple frame EIS. Further, the device 500 may be multi-tasking multiple applications. As a result, the amount of processing resources available for performing multiple frame EIS may be limited based on the other applications being executed. The device 500 therefore may reduce (or increase) the number of frames to be stored based on the available processing resources of the device 500.

In another example, the device 500 may adjust the number of frames to be stored based on a frame capture rate of the camera 502. If the camera captures frames at an increasing rate (such as from 30 fps to 60 fps), less time exists between frame captures (such as every 0.33 ms vs. 0.17 ms between 30 fps and 60 fps, respectively). The device 500 may have less time to process the captured frames for video. As a result, the device 500 may reduce the number of frames to be stored when the frame capture rate of the camera 502 increases.

In another example, the device 500 may adjust the number of frames to be stored based on a measured movement of the camera 502. Larger camera movements may cause an EIS frame to be outside the frames stored for smaller camera movements. Therefore, if the camera movement increases, the device 500 may increase the number of frames to be stored. For example, the sensor controller 522 may use one or more of the gyroscope 520, the accelerometer 524, or the magnetometer 526 to measure the camera movement. The device 500 then may determine the number of frames to store based on the camera movement.

In some example implementations, the device 500 may trigger determining the number of frames to store each pre-defined number of frame captures or each pre-defined period of time during video recording. For example, the device 500 may determine the number of frames to store every 30 frames or every second (which may be equivalent if the camera 502 captures 30 fps).

In some other example implementations, if the number of frames to be stored is based on camera movement, the device 500 may trigger determining the number of frames to store when a change in camera movement is determined. For example, if a person is standing still, the device 500 may store x number of frames for multiple frame EIS. If the person begins to walk, the sensor controller 522 may determine that the camera movement is increasing. x may be increased by y based on the camera movement (x+y), and the device 500 may store x+y frames while the person is walking. If the device 500 determines that the person stops walking (such as the sensor controller 522 determining a decrease in camera movement), the device 500 may decrease the number of frames to be stored (such as back to x number of frames). In some other examples, the device 500 may compare a current frame and a prior frame to determine camera movement. For example, the displacement of objects in the scene between the frames may be determined, and the displacement may be used to determine the camera movement. In this manner, the device 500 may determine the number of frames to be stored based on the displacement of objects between frames.

If movement of the camera 502 is too quick, EIS may not be desired. For example, a user may consciously move a camera 502 quickly towards different objects in the scene. EIS may cause an undesired slowing in orienting a video towards the objects in the scene. The device 500 may determine whether not to perform multiple frame EIS based on the speed of the camera movement. In some example implementations, the sensor controller 522 may use one or more of the gyroscope 520, the accelerometer 524, or the magnetometer 526 to measure the speed of the camera movement. If the speed of the camera movement is greater than a speed threshold, the device 500 may determine not to perform multiple frame EIS.

Instead of determining not to perform multiple frame EIS, the device 500 may reduce the number of frames to be stored when the speed of the camera movement increases. As a result, when fewer frames are stored, less prior frames may be used for multiple frame EIS. In this manner, the device 500 may be more likely to not perform multiple frame EIS since fewer prior frames are available. In some example implementations, the number of frames to be stored in the buffer 509 may be based on the size of the camera movement and the speed of the camera movement. The number of frames to be stored may be directly related to the size of the camera movement, and the number of frames to be stored may be inversely related to the size of the camera movement. In some example implementations, the device 500 may store a mapping or otherwise determine the number of frames to be stored based on different sizes of camera movement and different speeds of camera movement.

In a further example, the device 500 may determine the number of frames to be stored in the buffer 509 based on local motion in the scene. The device 500 may compare successive frames to determine regions of the scene affected by local motion and the amounts of local motion for the affected regions. The number of frames to be stored may be inversely related to the local motion in the scene. For example, if the device 500 is recording a live sporting event or another scene with significant local motion, the prior frames may be less relevant for filling portions of an EIS image for a current frame since the scene information may change between capture of the prior frames and capture of the current frame. As a result, image information may become stale more quickly for scenes with more local motion (e.g., a sporting event) than for scenes with less local motion (e.g., a landscape scene with few objects moving). The device 500 therefore may reduce the number of frames to be stored if determined that the local motion in the scene increases.

In some example implementations, the device 500 may use a combination of different factors in determining the number of frames to be stored in the buffer 509. For example, the available volatile memory or other computing resources of the device 500 may limit the number of frames to be stored to a maximum. Additionally or alternatively, the device 500 may determine the number of frames to be stored based on two or more of the latency requirement of the imaging application, the size and speed of the camera movement, the local motion in the scene, the rate of frame capture for the camera 502, or other suitable factors. For example, each factor may indicate a number of frames to be stored, and the device 500 may select the smallest number as the number of frames to be stored in the buffer 509.

After the device 500 fills all pixels in an EIS image with image information from current and prior frames, the device 500 may blend or otherwise combine information from different frames so that the EIS image does not appear disjointed for different regions. For example, if the lighting slightly changes between frame captures, neighboring portions of an EIS image (from different frames) may have a different luminance. The device 500 thus may process the EIS image to have a uniform luminance (such as adjusting the luminance of the region filled by a prior frame). Any suitable blending or stitching of regions in generating and processing the EIS image may be performed by the device 500.

While the above examples (such as the example operation 800 in FIG. 8) describe using increasingly older prior frames to determine the image information for a pixel, the device 500 may skip one or more prior frames when using increasingly older prior frames. For example, the device 500 may determine that the image information from a prior frame 1 is not suitable for the EIS image for the current frame. For example, a bird or other object may have flown into the scene corresponding to the region of the EIS image to be filled using a prior frame. The device 500 may determine a threshold change in chrominance or luminance between a region of the EIS image filled by the current frame and a neighboring region of the EIS image that may be filled by the prior frame 1. As a result, the device 500 may not use the prior frame 1, and proceed to determining if a prior frame 2 should be used. Any suitable prior frames may be used, and the present disclosure should not be limited to the example sequence of prior frames to be used for multiple frame EIS.

Further, while the above examples (such as the example operation 800 in FIG. 8) describe using one prior frame to determine the image information for a pixel, the device 500 may use multiple prior frames. For example, the device 500 may average the image information for a corresponding pixel between prior frames to determine an image information for a pixel of the EIS image. The average may be a simple average, where each prior frame is treated equally. Alternatively, the average may be a weighted average. For example, the device 500 may prioritize newer prior frames over earlier prior frames since the image information may be less stale for newer prior frames than for earlier prior frames. The weights for averaging may be determined in any suitable manner.

While the above examples have been described regarding a camera 502 having positional movement or rotational movement, camera movement also may cause the plane of capture to change. Further, a camera lens may cause warping or distortion of a captured frame. For example, a wide angle lens may cause captured frames to appear squeezed at the edges of the frame (with more of the scene captured by regions closer to the edge of the camera sensor), which may appear as a fish-eye effect. In another example, the camera 502 may be moved toward or away from the scene, or the pitch or yaw of the camera 502 may be changed, changing the plane of capture for the camera 502. In performing multiple frame EIS, the device 500 may perform de-warping for the current and prior frames to adjust the frames to have a common plane of capture and to rectify any warping caused by the camera lens. In this manner, the device 500 may align the frames when determining image information for an EIS image.

The device 500 may generate an EIS image for each captured frame from the camera 502, and the device 500 may process the stream of EIS images in generating the final video. Processing the stream of EIS images may include any suitable operations performed in the image processing pipeline, including edge enhancement, blurring, color balance, etc. After processing the stream of EIS images, the device 500 may store, present for viewing, or otherwise output the processed stream of EIS images as the recorded video.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 506 in the example device 500 of FIG. 5) comprising instructions 508 that, when executed by the processor 504 (or the camera controller 510 or the image signal processor 512), cause the device 500 to perform one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 504 or the image signal processor 512 in the example device 500 of FIG. 5. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. For example, the steps of the described example operations, if performed by the device 500, the camera controller 510, the processor 504, and/or the image signal processor 512, may be performed in any order and at any frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

1. A device for performing multiple frame electronic image stabilization (EIS), comprising:
a memory; and
a processor coupled to the memory and configured to:
receive a current frame for performing multiple frame EIS;
determine a location of a cropping in the current frame for an EIS image;
crop current image information from the current frame using the cropping, wherein the cropped current image information is included in the EIS image;
determine a portion of the cropping for the EIS image not in the current frame;
retrieve, from the memory, prior image information for the portion of the cropping from one or more prior frames in response to determining the portion of the cropping not in the current frame; and
generate, for the current frame, the EIS image including the current image information and the prior image information.

2. The device of claim 1, wherein the memory includes a buffer configured to store a number of prior frames and the current frame for multiple frame EIS.

3. The device of claim 2, further comprising a camera configured to capture the current frame and the prior frames, wherein the number of prior frames to be stored in the buffer is adjustable.

4. The device of claim 3, wherein the number of prior frames to be stored is based on a determined movement of the camera.

5. The device of claim 3, wherein the number of prior frames to be stored is based on available processing resources of the device.

6. The device of claim 3, wherein the number of prior frames to be stored is based on a latency requirement of an imaging application executed by the device.

7. The device of claim 2, wherein the processor is further configured to:
retrieve a prior frame stored in the buffer;
align the current frame and the prior frame; and
determine that the portion of the cropping is in the prior frame, wherein the prior image information is from the prior frame.

8. The device of claim 7, wherein the processor is further configured to:
perform a de-warping operation to adjust the prior frame to have a common plane of capture with the current frame and to rectify any warping in the prior frame and the current frame caused by a lens of a camera.

9. A method for performing multiple frame electronic image stabilization (EIS), comprising:
receiving, by a processor, a current frame for multiple frame EIS;
determining a location of a cropping in the current frame for an EIS image;
cropping current image information from the current frame using the cropping, wherein the cropped current image information is included in the EIS image;
determining a portion of the cropping for the EIS image not in the current frame;
retrieving, from a memory, prior image information for the portion of the cropping from one or more prior frames in response to determining the portion of the cropping not in the current frame; and
generating, for the current frame, the EIS image including the current image information and the prior image information.

10. The method of claim 9, further comprising storing a number of prior frames and the current frame for multiple frame EIS.

11. The method of claim 10, further comprising capturing the current frame and the prior frames by a camera, wherein the number of prior frames to be stored is adjustable.

12. The method of claim 11, wherein the number of prior frames to be stored is based on a determined movement of the camera.

13. The method of claim 11, wherein the number of prior frames to be stored is based on available processing resources.

14. The method of claim 11, wherein the number of prior frames to be stored is based on a latency requirement of an imaging application being executed.

15. The method of claim 10, further comprising:
retrieving a prior frame stored in the memory;
aligning the current frame and the prior frame; and
determining that the portion of the cropping is in the prior frame, wherein the prior image information is from the prior frame.

16. The method of claim 15, further comprising:
performing a de-warping operation to adjust the prior frame to have a common plane of capture with the current frame and to rectify any warping in the prior frame and the current frame caused by a lens of a camera.

17. A non-transitory computer-readable medium storing one or more programs containing instructions that, when executed by a processor of a device, cause the device to:
receive a current frame for multiple frame EIS;
determine a location of a cropping in the current frame for an EIS image;
crop current image information from the current frame using the cropping, wherein the cropped current image information is included in the EIS image;
determine a portion of the cropping for the EIS image not in the current frame;
retrieve, from a memory, prior image information for the portion of the cropping from one or more prior frames in response to determining the portion of the cropping not in the current frame; and
generate, for the current frame, the EIS image including the current image information and the prior image information.

18. The computer readable medium of claim 17, wherein execution of the instructions further causes the device to store, in the memory, a number of prior frames and the current frame for multiple frame EIS.

19. The computer readable medium of claim 18, wherein execution of the instructions further causes the device to capture the current frame and the prior frames by a camera, wherein the number of prior frames to be stored in the memory is adjustable.

20. The computer readable medium of claim 19, wherein the number of prior frames to be stored is based on a determined movement of the camera.

21. The computer readable medium of claim 19, wherein the number of prior frames to be stored is based on available processing resources.

22. The computer readable medium of claim 19, wherein the number of prior frames to be stored is based on a latency requirement of an imaging application being executed.

23. The computer readable medium of claim 18, wherein execution of the instructions further causes the device to:
retrieve a prior frame stored in the memory;
align the current frame and the prior frame; and
determine that the portion of the cropping is in the prior frame, wherein the prior image information is from the prior frame.

24. A device for performing multiple frame electronic image stabilization (EIS), comprising:
means for receiving a current frame for multiple frame EIS;
means for determining a location of a cropping in the current frame for an EIS image;
means for cropping current image information from the current frame using the cropping, wherein the cropped current image information is included in the EIS image;
means for determining a portion of the cropping for the EIS image not in the current frame;
means for retrieving prior image information for the portion of the cropping from one or more prior frames in response to determining the portion of the cropping not in the current frame; and
means for generating, for the current frame, the EIS image including the current image information and the prior image information.

25. The device of claim 24, further comprising means for storing a number of prior frames and the current frame for multiple frame EIS.

26. The device of claim 25, further comprising means for capturing the current frame and the prior frames, wherein the number of prior frames to be stored is adjustable.

27. The device of claim 26, wherein the number of prior frames to be stored is based on a determined movement when capturing frames.

28. The device of claim 26, wherein the number of prior frames to be stored is based on available processing resources of the device.

29. The device of claim 26, wherein the number of prior frames to be stored is based on a latency requirement of an imaging application being executed by the device.

30. The device of claim 25, further comprising:
means for retrieving a prior frame stored by the device;
means for aligning the current frame and the prior frame; and
means for determining that the portion of the cropping is in the prior frame, wherein the prior image information is from the prior frame.
